(19) United States
(12) Patent Application Publication
(10) Pub. No.: US 2025/0071835 A1
(43) Pub. Date: Feb. 27, 2025

(54) METHOD AND NON-TRANSITORY COMPUTER-READABLE STORAGE MEDIUM AND APPARATUS FOR TRANSMITTING AND RECEIVING WIRELESS MULTI-SOURCE PACKETS

(71) Applicant: Airoha Technology Corp., Hsinchu City (TW)

(72) Inventor: Ming-Yi HSIEH, Hsinchu County (TW)

(73) Assignee: Airoha Technology Corp., Hsinchu City (TW)

(21) Appl. No.: 18/236,072

(22) Filed: Aug. 21, 2023

(51) Int. Cl. H04W 76/15; H04L 5/00; H04W 72/0446

(52) U.S. Cl. CPC H04W 76/15; H04L 5/0044; H04W 72/0446

(57) ABSTRACT

The invention relates to methods, non-transitory computer-readable storage medium, and apparatus for transmitting and receiving a wireless multi-source packet. A processing unit of a first audio-data transmitter device obtains data-slot assignments indicating that a first data slot is assigned to a second audio-data transmitter device and a second data slot is assigned to first audio-data transmitter device for data transmission from a audio-data receiver device; tunes in a first physical channel in the first data slot to obtain a first frame from the second audio-data transmitter device; obtains a second frame including a chunk of second audio data originated by the first audio-data transmitter device; encapsulates the first frame and the second frame into a payload of a media packet; and transmits the media packet at a second physical channel to the audio-data receiver device in the second data slot.

### BACKGROUND

The disclosure generally relates to wireless transmission and, more particularly, to methods, non-transitory computer readable storage media and apparatuses for transmitting and receiving wireless multi-source packets.

The wireless system may be configured as multiple transmitter devices and a single receiver device, and in the wireless system the receiver device operates like a master device to coordinate the packet transmissions by the transmitter devices while the transmitter devices operate like slave devices. For example, the wireless microphone system includes the wireless system with the above configurations. In the wireless microphone system, each handheld, handset or lavalier microphone turns audio signals captured mainly from humans into digital data, which is transmitted by a transmitter device thereof. A consumer electronic product is equipped with the receiver device to receive audio data from the transmitter devices. The consumer electronic product may be a digital camera, a digital video recorder, a karaoke host, or others.

### SUMMARY

The disclosure relates to an embodiment of a method for transmitting a wireless multi-source packet, which is performed by a processing unit of a first audio-data transmitter device, to include: obtaining data-slot assignments indicating that a first data slot is assigned to a second audio-data transmitter device and a second data slot is assigned to first audio-data transmitter device for data transmission from an audio-data receiver device; tuning in a first physical channel in the first data slot to obtain a first frame from the second audio-data transmitter device, where the first frame comprises a chunk of first audio data originated by the second audio-data transmitter device; obtaining a second frame comprising a chunk of second audio data originated by the first audio-data transmitter device; encapsulating the first frame and the second frame into a payload of a media packet; and transmitting the media packet at a second physical channel to the audio-data receiver device in the second data slot.

The disclosure further relates to an embodiment of a non-transitory computer-readable storage medium having stored therein program code that, when loaded and executed by a processing unit of a first audio-data transmitter device, causes the processing unit to perform the method for transmitting a wireless multi-source packet.

The disclosure further relates to an embodiment of an apparatus for transmitting a wireless multi-source packet, to include a processing unit. The processing unit is arranged operably to: obtain data-slot assignments indicating that a first data slot is assigned to a second audio-data transmitter device and a second data slot is assigned to first audio-data transmitter device for data transmission from an audio-data receiver device; drive a radio frequency (RF) module and a modulator-demodulator (MODEM) to tune in a first physical channel in the first data slot to obtain a first frame from the second audio-data transmitter device, where the first frame comprises a chunk of first audio data originated by the second audio-data transmitter device; obtain a second frame comprising a chunk of second audio data originated by the first audio-data transmitter device; encapsulate the first frame and the second frame into a payload of a media packet; and drive the RF module and the MODEM to transmit the media packet at a second physical channel to the audio-data receiver device in the second data slot.

The disclosure relates to an embodiment of a method for receiving a wireless multi-source packet, which is performed by a processing unit of an audio-data receiver device, to include: transmitting first data-slot assignments indicating that a first data slot is assigned to a second audio-data transmitter device and a second data slot is assigned to a first audio-data transmitter device for data transmission to the first audio-data transmitter device; transmitting a first transmission mode being set to a specific mode, and a first physical-channel configuration to the first audio-data transmitter device, thereby enabling the first audio-data transmitter device to relay a first frame that is listened in the first data slot to the audio-data receiver device, where the first frame comprises a chunk of first audio data originated by the second audio-data transmitter device; and tuning in a first physical channel in the second data slot to receive a first media packet from the first audio-data transmitter device, where the first media packet comprises a first payload carrying the first frame and a second frame and the second frame comprises a chunk of second audio data originated by the first audio-data transmitter device.

The disclosure further relates to an embodiment of a non-transitory computer-readable storage medium having stored therein program code that, when loaded and executed by a processing unit of an audio-data receiver device, causes the processing unit to perform the method for receiving a wireless multi-source packet.

The disclosure further relates to an embodiment of an apparatus for receiving a wireless multi-source packet, to include a processing unit. The processing unit is arranged operably to: transmit first data-slot assignments indicating that a first data slot is assigned to a second audio-data transmitter device and a second data slot is assigned to a first audio-data transmitter device for data transmission to the first audio-data transmitter device; transmit a first transmission mode being set to a specific mode, and a first physical-channel configuration to the first audio-data transmitter device, thereby enabling the first audio-data transmitter device to relay a first frame that is listened in the first data slot to the audio-data receiver device, where the first frame comprises a chunk of first audio data originated by the second audio-data transmitter device; and drive a RF module and a MODEM to tune in a first physical channel in the second data slot to receive a first media packet from the first audio-data transmitter device, where the first media packet comprises a first payload carrying the first frame and a second frame and the second frame comprises a chunk of second audio data originated by the first audio-data transmitter device.

Both the foregoing general description and the following detailed description are examples and explanatory only, and are not restrictive of the invention as claimed.

### BRIEF DESCRIPTION OF THE DRAWINGS

FIG. 1 is a schematic diagram of a wireless system according to an embodiment of the present invention.

FIG. 2 is the system architecture installed in any of audio-data transmitter devices and a audio-data receiver device according to an embodiment of the present invention.

FIG. 3 is a wireless transmission timing diagram for transmitting audio data by two transmitter devices according to some implementations.

FIG. 4 shows a wireless transmission timing diagram for allowing any audio-data transmitter device to connect to a audio-data receiver device according to an embodiment of the present invention.

FIG. 5 shows a wireless transmission timing diagram for transmitting audio data by two audio-data transmitter devices in the relay mode and receiving by one audio-data receiver device in the normal mode according to an embodiment of the present invention.

FIG. 6 shows a wireless transmission timing diagram for transmitting audio data by four transmitter devices in the prolong relay mode and receiving by one audio-data receiver device in the interlaced mode according to an embodiment of the present invention.

FIG. 7 is a flowchart of a method for executing tasks for each data slot, which is performed by a processing unit of a audio-data transmitter device, according to an embodiment of the present invention.

FIG. 8 is a flowchart of a method for executing tasks for each data slot, which is performed by a processing unit of a audio-data receiver device, according to an embodiment of the present invention.

### DETAILED DESCRIPTION

Reference is made in detail to embodiments of the invention, which are illustrated in the accompanying drawings. The same reference numbers may be used throughout the drawings to refer to the same or like parts, components, or operations.

The present invention will be described with respect to particular embodiments and with reference to certain drawings, but the invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words described the relationship between elements should be interpreted in a like fashion (e.g., “between” versus “directly between,” “adjacent” versus “directly adjacent.” etc.)

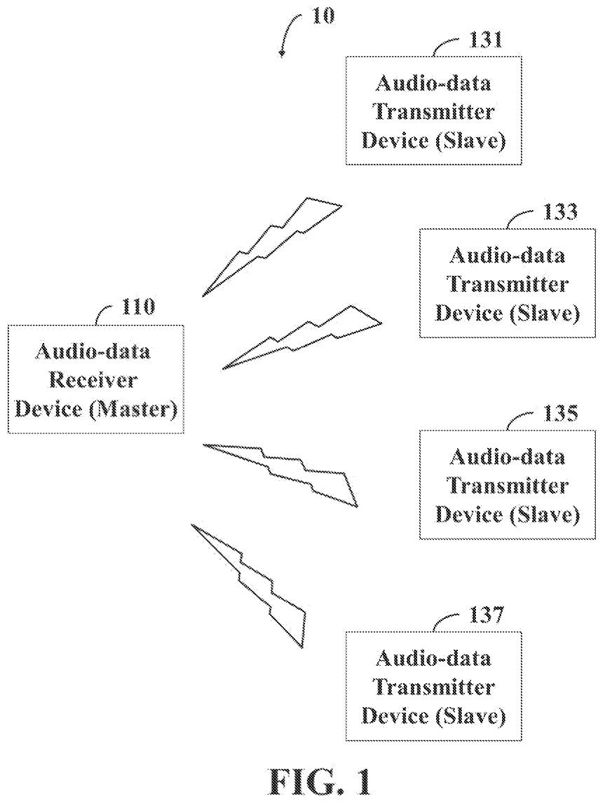

Refer to FIG. 1 showing a wireless system 10 including multiple audio-data transmitter devices 131, 133, 135 and 137, and a single audio-data receiver device 110. Each audio-data transmitter device is installed in an audio-data collecting device, such as a handheld, handset or lavalier wireless digital microphone, which is used to pick up sound mainly from humans and digitalize the picked-up sound into digital audio data. The audio-data receiver device 110 is installed in a digital camera or a digital video recorder for recording and storing the digital audio data, or a karaoke host for converting the digital audio data into analog voice signals, mixing the analog voice signals with other analog signals by musical instruments and amplifying the mixed analog signals. In the wireless system 10, the audio-data receiver device 110 operates as a master device to control timing and physical channels of packet transmissions performed by each of the audio-data transmitter devices 131, 133, 135 and 137 and serve as their communication gateway. Each audio-data transmitter device operates as a slave device to transmit packets carrying digital audio data to the audio-data receiver device 110 in designated time intervals individually with a designated physical channel. It may use a wireless communications protocol between the audio-data receiver device 110 and any of the audio-data transmitter devices 131, 133, 135 and 137, such as Bluetooth low energy Audio (LE Audio), extended Synchronous Connection-Oriented (eSCO), Asynchronous Connection-Oriented (ACL), etc., to transfer packets carrying digital audio data

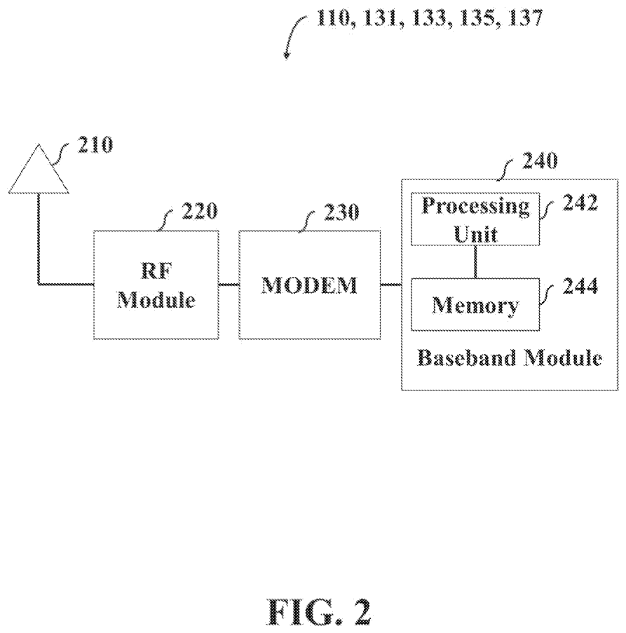

Refer to FIG. 2 showing an embodiment of the system block applied in any of the audio-data receiver device 110, the audio-data transmitter devices 131, 133, 135 and 137. The system architecture includes the antenna 210, the radio frequency (RF) module 220, the modulator-demodulator (MODEM) 230 and the baseband module 240. The baseband module 240 includes the processing unit 242 and the memory 244. The processing unit 242 may be implemented in numerous ways, such as with general-purpose hardware (e.g., a microcontroller unit, a digital signal processor, a single processor, multiple processors or graphics processing units capable of parallel computations, or others) that is programmed using firmware, software instructions or the both to perform the functions recited herein. The memory 244 may allocate space as a data buffer temporarily storing the media packet(s) that has been obtained from the medium, which are originally transmitted to other devices, and collected audio data to be transmitted to the medium. The memory 244 further stores data needed during execution, such as variables, data tables, and so on. The processing unit 242 may couple the memory 244 to access data through a bus architecture.

In adaptive frequency hopping (AFH), the audio-data receiver device 110 may send the same channel map to the audio-data transmitter devices 131, 133, 135 and 137. The channel map instructs the audio-data transmitter devices 131, 133, 135 and 137 to use the specific one of the multiple physical channels (for example, 37 physical channels) in the 2.4 to 2.48 GHz frequency band in each time interval (or time slot) to receive data or transmit data, thereby enabling the corresponding RF module 220 to receive or transmit data in each time interval on the designated physical channel. The audio-data receiver device 110 may establish different isochronous links with the audio-data transmitter devices 131, 133, 135 and 137, respectively, and each link uses a specified logical transport and supports bi-directional communication. The RF module 220 is employed to receive RF signal in the medium and convert the received RF signal into baseband signal that can be processed by the MODEM 230. The RF module 220 is also employed to receive baseband signal from the MODEM 230 and convert the received baseband signal into RF signal that can be sent to the medium. The RF module 220 may include a mixer to generate a new frequency according to the input signal, and the signal output from a local oscillator. The MODEM 230 may implement Gaussian Frequency Shift Keying (GFSK), π/4-Differenttial Quadrature Phase Shift Keying (DQPSK), 8-Differential Phase Shift Keying (DPSK), or others.

In wireless audio-data communications, no acknowledgement mechanism is employed to ensure the network packets transmitted from any audio-data transmitter device to be safely received by the audio-data receiver device 110 through a media. In a common scenario, one chunk of audio data with the related cyclical redundancy check (CRC) is transmitted by any audio-data transmitter device to the audio-data receiver device 110 at least three times to improve the reliability. For example, the length of one chunk of audio data and its related CRC is 200 bits (i.e. 25 bytes). One chunk of audio data and the related CRC may be referred to as one frame collectively The audio-data receiver device 110 determines whether the received audio-data chunk with the CRC in each frame is correct by using a well-known error-check algorithm. The audio-data reception is successful when the received audio-data chunk with the CRC in any of three frames passes the verification with the error-check algorithm.

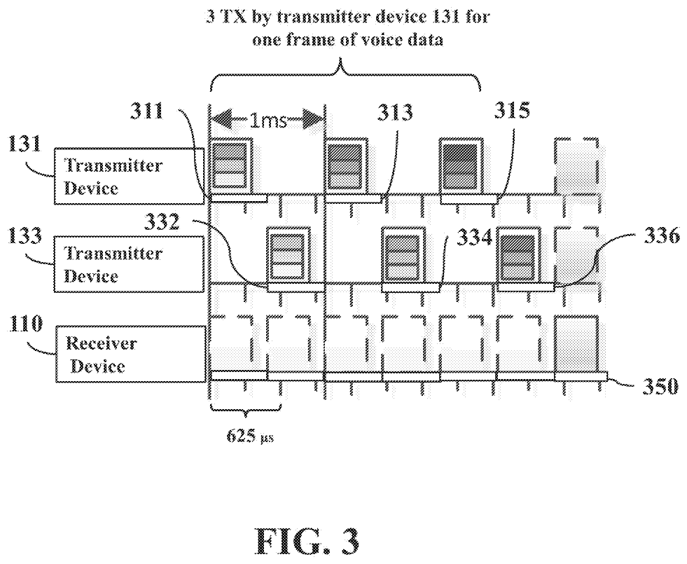

In some implementations, for example, the audio-data transmitter devices 131 and 133 transmit one audio-data chunk with the related CRC to the audio-data receiver device 110 in the interlaced manner. However, more latency is produced when two or more audio-data transmitter devices appear in the wireless network. Refer to FIG. 3 showing a wireless transmission timing diagram illustrating transmitting audio data by two transmitter devices 131 and 133. Each event occurs with a regular interval and contains six data slots and one control signal slot. Specifically, the audio-data transmitter device 131 transmits one chunk of audio data with the related CRC (so-called frame A), which is originated by the audio-data transmitter device 131, to the audio-data receiver device 110 for the first time in the data slot 311. The audio-data transmitter device 133 transmits one chunk of audio data with the related CRC (so-called frame B), which is originated by the audio-data transmitter device 133, to the audio-data receiver device 110 for the first time in the data slot 332. The audio-data transmitter device 131 transmits the frame A to the audio-data receiver device 110 for the second time in the data slot 313. The audio-data transmitter device 133 transmits the frame B to the audio-data receiver device 110 for the second time in the data slot 334, and so on. The audio-data receiver device 110 transmits updated setup parameters for the isochronous links in the following events to the audio-data transmitter devices 131 and 133 in the control signal slot 350. The audio-data transmitter device 131 deems the data slots 311, 313 and 315 as transmission (TX) slots for transmitting the frame A while the audio-data receiver device 110 deems the data slots 311, 313 and 315 as reception (RX) slots for receiving the frame A. The audio-data transmitter device 133 deems the data slots 311, 313 and 315 as idle slots. The audio-data transmitter device 133 deems the data slots 332, 334 and 336 as TX slots for transmitting the frame B while the audio-data receiver device 110 deems the data slots 332, 334 and 336 as RX slots for receiving the frame B. The audio-data transmitter device 131 deems the data slots 332, 334 and 336 as idle slots. The audio-data receiver device 110 deems the control signal slot 350 as a TX slot for transmitting the updated setup parameters while the audio-data transmitter devices 131 and 133 deem the control signal slot 350 as a RX slot for receiving the updated setup parameters. Additional latency (about 3 ms−about 1.5 ms=about 1.5 ms) is generated when the audio-data transmitter devices 131 and 133 appear in the wireless network. The additional latency is 15% per 10 ms and is 22% per 6.8 ms.

In order to reduce the additional latency because of two or more audio-data transmitter devices connect to the audio-data receiver device 110 in the wireless network, an embodiment of the invention introduces the relay mechanism. Although the specification describes the shortcomings of the above implementation, this is only used to illustrate the inspiration of embodiments of the present invention as follows. Those artisans may apply the technical solutions to solve other technical problems or be applicable to other technical environments, and the invention should not be limited thereto.

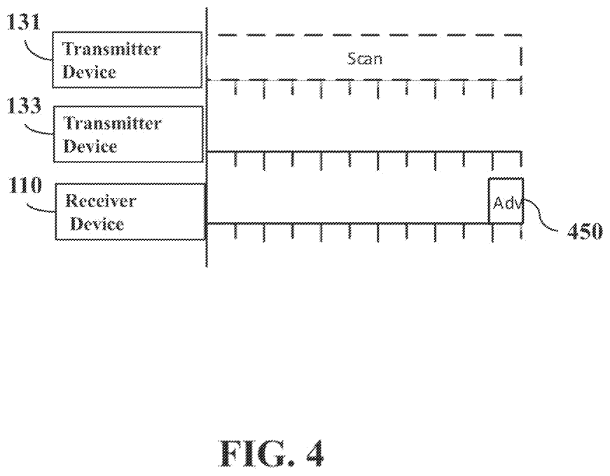

The relay mechanism may be implemented with the Bluetooth Low Energy (LE) specification as an example. Refer to FIG. 4 showing a wireless transmission timing diagram illustrating allowing any audio-data transmitter device to connect to the audio-data receiver device 110. The audio-data receiver device 110 periodically broadcasts LE advertising (ADV) packets to advertise the name and the ID of the audio-data receiver device 110, a short list of services, which includes such as an audio-data host, etc., and information indicating that the LE ADV packet can be responded and the advertising device can be connected. Any of the audio-data transmitter device 131, 133, 135 and 137 scans the designated physical channels, such as channels #37, #38 and #39, to discover a LE ADV packet. For example, once detecting the advertising packet 450 broadcasted by the audio-data receiver device 110, the audio-data transmitter device 131 sends a scan request carrying the name and the ID of the audio-data transmitter device 131 to the audio-data receiver device 110. The audio-data receiver device 110 sends a scan response to the audio-data transmitter device 131 in a control signal slot. The audio-data transmitter device 131 sends a link layer (LL) connect request to the audio-data receiver device 110 for requesting to establish a link with the audio-data receiver device 110. Once the audio-data receiver device 110 responds with an acknowledgement and setup parameters to the audio-data transmitter device 131, a link has been established between the audio-data receiver device 110 and the audio-data transmitter device 131. The setup parameters may include but not limited to the start times of the following events, the offsets to the data slots and the control signal slot from the start time of each following event, physical-channel configurations used in this link, an encryption key, and a transmission mode. The physical-channel configurations may include settings for a channel hopping algorithm, such as a channel map, constants used in a channel selection equation, etc.

Any of the audio-data transmitter devices 133, 135 and 137 may use the same procedure to connect to the audio-data receiver device 110. Since two to four audio-data transmitter devices can connect to the audio-data receiver device 110 and produce more additional latency, in some embodiments, the audio-data receiver device 110 enters one of two reception modes and directs each of the connected audio-data transmitter devices to operate in one of four transmission modes depending on a total number of the audio-data transmitter device or devices that has or have connected to the audio-data receiver device 110. The reception modes include: a normal mode and an interlaced mode. The audio-data receiver device 110 uses a variable to record, in the memory 244, a reception mode in which the audio-data receiver device 110 is operating. The transmission modes include a normal mode, a relay mode, a prolong normal mode, and a prolong relay mode. Any audio-data transmitter device uses a variable to record, in the memory 244, a transmission mode in which the audio-data transmitter device is operating. Several scenarios are provided below to illustrate the technical details for the two reception modes and the four transmission modes.

In the first scenario, if there is no audio-data transmitter device which has connected to the audio-data receiver device 110, the audio-data receiver device 110 enters the normal mode and directs the requested audio-data transmitter device to operate in the normal mode.

Assume that the audio-data transmitter devices 131 is the first device to request the audio-data receiver device 110 for establishing a link for transmitting audio data. The audio-data receiver device 110 directs the audio-data transmitter devices 131 to operate in the normal mode by responding with the setup parameters including the transmission mode being set to the normal mode to the audio-data transmitter devices 131. In the normal mode, the audio-data transmitter device 131 occupies all data slots to transmit audio-data chunks with the related CRC (referred to as frames collectively) to the audio-data receiver device 110. Frames to be sent are queued in a First-In First-Out (FIFO) in the audio-data transmitter devices 131. The FIFO may be practiced in an allocated space of the memory 244 in the audio-data transmitter devices 131.

To limit the transmission times for the same frame, each frame is attached to a flush timeout value. The flush timeout value is a timestamp indicating the time at which the corresponding frame is generated or is pushed into the FIFO plus a predefined time period (e.g. 1.5 ms). For each data slot, the audio-data transmitter device 131, if existed, drops the expired frame (that is, the frame with the flush timeout value, which is earlier than the start time of this data slot) from the top of the FIFO The audio-data transmitter device 131 picks up the available frame (that is, the frame with the flush timeout value, which is later than the start time of this data slot) from the top of the FIFO to transmit to the audio-data receiver device 110 in this data slot.

The obtained frame is enclosed in a media packet. The payload of each media packet may carry at most three frames. In the first scenario, the payload of each media packet carries one frame, and the header of the media packet records information about the device ID of the audio-data transmitter device 131, and the frame ID of the carried frame and the start bit number of the carried frame in the payload thereof. The audio-data transmitter device 131 is considered as the data source of the carried frame.

For the transmission in each data slot, the audio-data transmitter device 131 tunes in a designated physical channel by using the channel hopping algorithm according to the physical-channel configurations set by the audio-data receiver device 110. Regularly, each frame is transmitted by the audio-data transmitter device 131 in the normal mode three times to the audio-data receiver device 110 under the control with the related flush timeout value when each data slot can be used to transmit at most 75 bytes of data and the predefined time period is set to 1.5 ms. The audio-data receiver device 110 operating in the normal mode tunes in a designated physical channel to listen in each data slot by using the channel hopping algorithm according to the same physical-channel configurations as that set to the audio-data transmitter device 131.

In the second scenario, if there is one audio-data transmitter device (e.g., audio-data transmitter device 131) which has connected to the audio-data receiver device 110, the audio-data receiver device 110 enters or keeps in the normal mode and directs both the connected audio-data transmitter device (e.g., audio-data transmitter device 131) and another requested audio-data transmitter device (e.g., audio-data transmitter device 133) to operate in the relay mode.

Assume that the audio-data transmitter device 131 has connected to the audio-data receiver device 110, which is illustrated in the first scenario, and the audio-data transmitter device 133 requests the audio-data receiver device 110 for establishing a link for transmitting audio data. The audio-data receiver device 110 directs the audio-data transmitter device 131 to change to operate in the relay mode by sending the updated setup parameters including a transmission mode and data-slot assignments to the audio-data transmitter device 131 in a control signal slot, where the transmission mode is set to the relay mode and the data-slot assignments indicate that the even number of data slots are assigned to the audio-data transmitter device 131 and the odd number of data slots are assigned to the audio-data transmitter device 133 for data transmission. Note that, the starting data slot in each event is denoted as the 0^{th} data slot (i.e. an even number of data slot).

The audio-data receiver device 110 responds with the setup parameters including the same transmission mode and the same data-slot assignments to the audio-data transmitter device 133, thereby enabling the audio-data transmitter device 133 to operate in the relay mode in coordination with the audio-data transmitter device 131. The setup parameters sent to the audio-data transmitter device 133 further includes the same physical-channel configurations as that is set to the audio-data transmitter device 131, so that the audio-data transmitter devices 131 and 133 share the same link to tune in the same physical channel in each data slot.

In the relay mode, the audio-data transmitter device 131 occupies a half of data slots to transmit data to the audio-data receiver device 110 and the audio-data transmitter device 133 occupies the other half of data slots to transmit data to the audio-data receiver device 110 in the interlaced manner. Similarly, frames to be sent are queued in FIFO in the audio-data transmitter devices 131 and 133 and are attached to flush timeout values The predefined time period is the same as that in the normal mode for calculating the flush timeout values. For the transmission in each data slot, the audio-data transmitter device 131 or 133 tunes in a designated physical channel by using the channel hopping algorithm according to the physical-channel configurations set by the audio-data receiver device 110. Regularly, each frame is transmitted by the audio-data transmitter devices 131 and 133 in the relay mode three times to the audio-data receiver device 110 under the control with the related flush timeout value when each data slot can be used to transmit at most 75 bytes of data and the predefined time period is set to 1.5 ms.

To make the audio-data transmission more efficient, in addition to transmitting the frames originated by itself, each of the audio-data transmitter devices 131 and 133 also relays frames originated from the other audio-data transmitter device. The audio-data receiver device 110 operating in the normal mode tunes in a designated physical channel to listen in each data slot by using the channel hopping algorithm according to the same physical-channel configurations as that set to the audio-data transmitter devices 131 and 133.

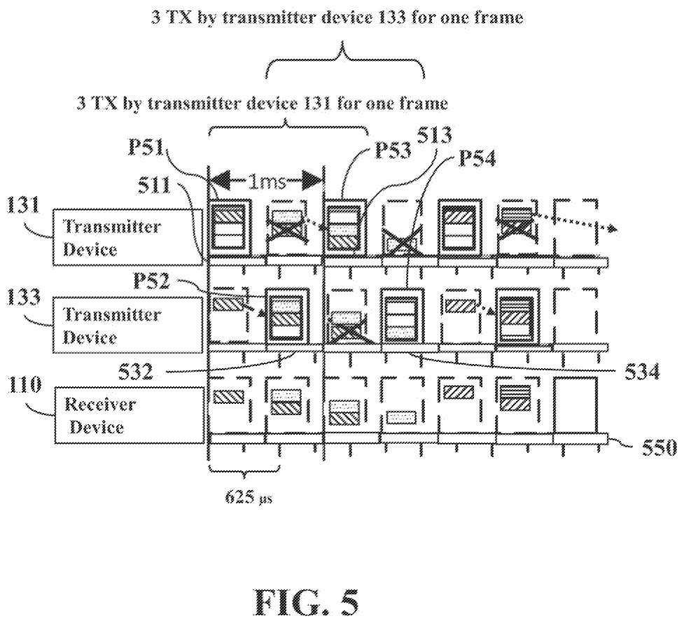

Refer to FIG. 5 showing a wireless transmission timing diagram for transmitting audio data by the audio-data transmitter devices 131 and 133 in the relay mode and receiving by the audio-data receiver device 110 in the normal mode. Each event occurs with a regular interval and contains six data slots and one control slot. Although the numbers, such as 511, 532, 513, 534 and 550, are provided to indicate the slots, which is used to transmit data by a specific device, so-called TX slots, they can also indicate the corresponding RX slots but are omitted for the brevity of FIG. 5. For example, the number 511 not only indicates the data slot for the audio-data transmitter devices 131, but also indicates the data slots aligned vertically to the data slot 511 for the audio-data transmitter device 133 and the audio-data receiver device 110.

In the data slot 511, the audio-data transmitter device 131 transmits one chunk of audio data with the related CRC (so-called the frame A, shown as the block filled with slashes), which is originated by the audio-data transmitter device 131, to the audio-data receiver device 110 for the first time while the audio-data transmitter device 133 and the audio-data receiver device 110 listen to the physical channel hopped in the data slot 511 and store the listened data (including the frame A theoretically) in the memory thereof. The frame A is enclosed in the payload of the media packet P51. The header of the media packet P51 records information about the device ID of the audio-data transmitter device 131, the frame ID of the frame A, and the start bit number of the frame A in the payload thereof.

In the data slot 532, the audio-data transmitter device 133 transmits one chunk of audio data with related CRC (so-called the frame B, shown as the block filled with dots), which is originated by the audio-data transmitter device 133, to the audio-data receiver device 110 for the first time, and transmits the data listened in the data slot 511 to the audio-data receiver device 110 for the second time while and the audio-data receiver device 110 listens to the physical channel hopped in the data slot 532 and store the listened data (including the frames A and B theoretically) in the memory thereof. The frames A and B are enclosed in the payload of the media packet P52. The header of the media packet P52 records information about the device ID of the audio-data transmitter device 131, the frame ID of the frame A and the start bit number of the frame A in the payload thereof, and a flush timeout value attached to the frame A, as well as the device ID of the audio-data transmitter device 133, the frame ID of the frame B and the start bit number of the frame B in the payload thereof, and a flush timeout value attached to the frame B. The audio-data transmitter device 131 also listens to the physical channel hopped in the data slot 532 and store a portion of listened data (including the frame B theoretically) in the memory thereof. It is to be understood that the audio-data transmitter device 131 drops the frame A listened in the data slot 532 because the frame A is originated by itself.

In the data slot 513, the audio-data transmitter device 131 transmits the frame A to the audio-data receiver device 110 for the third time and transmits the data, which includes the frame B, listened in the data slot 532 to the audio-data receiver device 110 for the second time while the audio-data receiver device 110 listens to the physical channel hopped in the data slot 513 and store the listened data (including frames A and B theoretically) in the memory thereof. The payload of the media packet P53 encloses the frames A and B, and the header of the media packet P53 records the aforementioned information for the frames A and B. The audio-data transmitter device 133 also listens to the physical channel hopped in the data slot 513 and store a portion of listened data (including the frame A theoretically) in the memory thereof. It is to be understood that the audio-data transmitter device 133 drops the frame B listened in the data slot 513 because the frame B is originated by itself.

In the data slot 534, the audio-data transmitter device 133 transmits the frame B for the third time while the audio-data transmitter device 131 and the audio-data receiver device 110 listens to the physical channel hopped in the data slot 534 and store the listened data (including frame B theoretically) in the memory thereof. In the data slot 534, the audio-data transmitter device 133 may drop the listened frame A because the audio-data transmitter device 133 detects that the flush timeout value for the listened frame A is earlier than the start time of the data slot 534. The payload of the media packet P54 encloses the frame B, and the header of the media packet P54 records the aforementioned information for the frame B.

The process of obtaining the data originated from the other audio-data transmitter device and transmitting the listened data to the audio-data receiver device 110 by the audio-data transmitter devices 131 or 133 is referred to as a relay process.

The audio-data receiver device 110 may transmit updated setup parameters, such as a new encryption key, new physical-channel configurations, and so on, for the following events to the audio-data transmitter devices 131 and 133 in the control signal slot 550. Comparing with FIG. 3, the additional latency as shown in FIG. 5 may be reduced by 1.5 ms when the transmitter devices 131 and 133 operate in the relay mode.

The audio-data transmitter device 131 in the relay mode deems the data slots 511 and 513 as TX slots for transmitting data while the audio-data transmitter device 133 in the relay mode and the audio-data receiver device 110 in the normal mode deems the data slots 511 and 513 as RX slots for receiving data. The audio-data transmitter device 133 in the relay mode deems the data slots 532 and 534 as TX slots for transmitting data while the audio-data transmitter device 131 in the relay mode and the audio-data receiver device 110 in the normal mode deems the data slots 532 and 534 as RX slots for receiving data. The audio-data receiver device 110 deems the control signal slot 550 as a TX slot for transmitting the updated setup parameters while the audio-data transmitter devices 131 and 133 deems the control signal slot 550 as a RX slot for receiving the updated setup parameters.

An audio-data collecting device equipped with the audio-data transmitter device 131 may further include a microphone and an analog-to-digital (ADC) converter. The microphone repeatedly collects voice signals (analog signals) mainly from humans and the ADC converter converts the analog signals into audio data. The processing unit 242 of the audio-data transmitter device 131 when loading and executing relevant firmware code, software code or the both continuously receives the audio data originated from the ADC, collects it into fixed-length chunks and calculates CRC of each chunk. One chunk of audio data and the associated CRC form the frame A. Similarly, an audio-data collecting device equipped with the audio-data transmitter device 133 may further include a microphone and an ADC converter to repeatedly generate audio data. The processing unit 242 of the audio-data transmitter device 133 when loading and executing relevant firmware code, software code or the both generates the frame B by applying a similar procedure to the audio data originated from the ADC of the audio-data collecting device.

In the third scenario, if there are two audio-data transmitter devices which have connected to the audio-data receiver device 110, the audio-data receiver device 110 enters the interlaced mode, directs the two connected audio-data transmitter devices to operate in the prolong relay mode and directs the requested audio-data transmitter device to operate in the prolong normal mode.

Assume that the audio-data transmitter devices 131 and 133 have connected to the audio-data receiver device 110, which is illustrated in the second scenario, and the audio-data transmitter device 135 requests the audio-data receiver device 110 for establishing a link for transmitting audio data. The audio-data receiver device 110 directs the audio-data transmitter devices 131 and 133 to change to operate in the prolong relay mode by sending the updated setup parameters including the transmission mode being set to the prolong relay mode to the audio-data transmitter devices 131 and 132 in a control signal slot. Technical details of the operations performed by the audio-data transmitter devices 131 and 132 operating in the prolong relay mode will be discussed in the fourth scenario as follows.

The audio-data receiver device 110 responses with the setup parameters including the transmission mode being set to the prolong normal mode to the audio-data transmitter device 135, thereby enabling the audio-data transmitter device 135 to operate in the prolong normal mode. The setup parameters sent to the audio-data transmitter device 135 may include different physical-channel configurations from that is set to the audio-data transmitter devices 131 and 133, so that the audio-data receiver device 110 establishes a different link with the audio-data transmitter devices 135. The audio-data receiver device 110 groups the audio-data transmitter devices 131 and 133 into the group A and groups the audio-data transmitter device 135 into the group B. The different physical-channel configurations for the groups A and B set by the audio-data receiver device 110 ensures that two physical channels that any group A's audio-data transmitter device and any group B's audio-data transmitter device tune in are different during the same time period.

In the prolong normal mode, the audio-data transmitter device 135 occupies all data slots to transmit audio-data chunks with the related CRC to the audio-data receiver device 110. Similarly, frames to be sent are queued in FIFO in the audio-data transmitter device 135 and are attached to flush timeout values. The predefined time period employed in the prolong normal mode is twice (e.g. 3 ms) as long as that in the relay mode or the normal mode for calculating the flush timeout values. For the transmission in each data slot, the audio-data transmitter device 135 tunes in a designated physical channel by using the channel hopping algorithm with the physical-channel configurations set by the audio-data receiver device 110. Regularly, each frame is transmitted six times to the audio-data receiver device 110 in the prolong normal mode under the control with the related flush timeout value when each data slot can be used to transmit at most 75 bytes of data and the predefined time period is set to 3 ms.

The audio-data receiver device 110 operating in the interlaced mode tunes in designated physical channels to listen in a half of data slots by using the channel hopping algorithm according to the physical-channel configurations set to the audio-data transmitter devices 131 and 133 and tunes in designated physical channels to listen in the other half of data slots by using the channel hopping algorithm according to the physical-channel configurations set to the audio-data transmitter device 135 in the interlaced manner. Technical details of the operations, which is performed by the audio-data receiver device 110, for receiving data from the audio-data transmitter devices of the groups A and B in the interlaced manner will be discussed in the fourth scenario as follows.

In the fourth scenario, if there are three audio-data transmitter devices have connected to the audio-data receiver device 110, the audio-data receiver device 110 enters the interlaced mode and directs the three connected audio-data transmitter device operating in the prolong normal mode to change to operate in the prolong relay mode and directs the requested audio-data transmitter device to operate in the prolong relay mode.

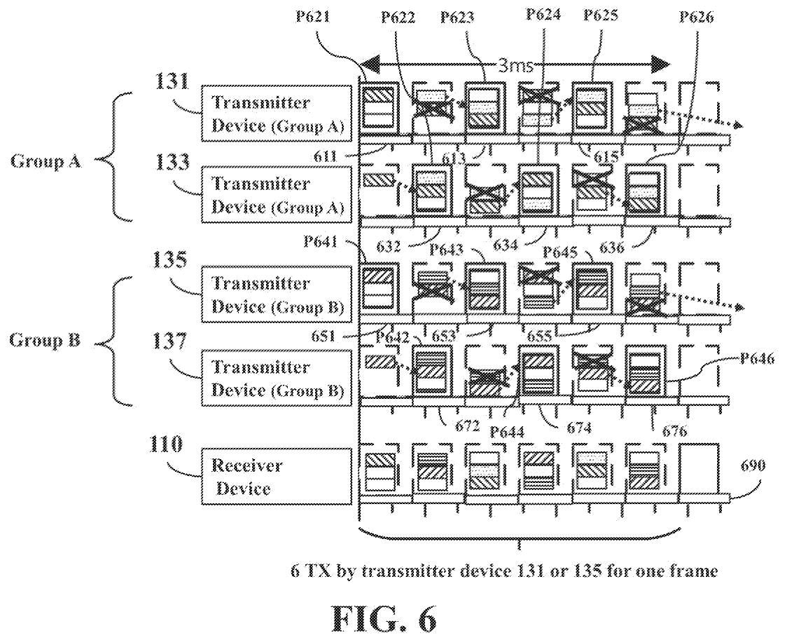

Assume that the audio-data transmitter devices 131, 133 and 135 have connected to the audio-data receiver device 110, which is illustrated in the third scenario, and the audio-data transmitter device 137 (shown in FIG. 6) requests the audio-data receiver device 110 for establishing a link for transmitting audio data. The audio-data receiver device 110 directs the audio-data transmitter device 135 to change to operate in the prolong relay mode by sending the updated setup parameters including a transmission mode and data-slot assignments to the audio-data transmitter device 135 in a control signal slot, where the transmission mode is set to the prolong relay mode and the data-slot assignments indicate that the even number of data slots are assigned to the audio-data transmitter device 135 and the odd number of data slots are assigned to the audio-data transmitter device 137 for data transmission. Note that, the starting data slot in each event is denoted as the 0^{th} data slot (i.e. an even number of data slot).

The audio-data receiver device 110 responds with the setup parameters including the same transmission mode and the same data-slot assignments to the audio-data transmitter device 137, thereby enabling the audio-data transmitter device 137 to operate in the prolong relay mode in coordination with the audio-data transmitter device 135. The setup parameters sent to the audio-data transmitter device 137 further includes the same physical-channel configurations as that is set to the audio-data transmitter device 135, so that the audio-data transmitter devices 131 and 133 share one link (so-called link A) and the audio-data transmitter devices 135 and 137 share another link (so-called link B). The audio-data receiver device 110 groups the audio-data transmitter devices 131 and 133 into the group A and groups the audio-data transmitter devices 135 and 137 into the group B.

In the prolong relay mode, the audio-data transmitter device 131 occupies a half of data slots of the link A to transmit data to the audio-data receiver device 110 and the audio-data transmitter device 133 occupies the other half of data slots of the link A to transmit data to the audio-data receiver device 110 in the interlaced manner. For the transmission or the reception in each data slot, the audio-data transmitter device 131 or 133 tunes in a designated physical channel by using the channel hopping algorithm with the physical-channel configurations set by the audio-data receiver device 110. Similarly, the audio-data transmitter device 135 in the prolong relay mode occupies a half of data slots of the link B to transmit data to the audio-data receiver device 110 and the audio-data transmitter device 137 in the prolong relay mode occupies the other half of data slots of the link B to transmit data to the audio-data receiver device 110 in the interlaced manner. For the transmission or the reception in each data slot, the audio-data transmitter device 135 or 137 tunes in a designated physical channel by using the channel hopping algorithm with the physical-channel configurations set by the audio-data receiver device 110. The predefined time period employed in the prolong relay mode is twice (e.g. 3 ms) as long as that in the relay mode or the normal mode for calculating the flush timeout values. Regularly, each frame is transmitted six times to the audio-data receiver device 110 in the prolong relay mode under the control with the related flush timeout value when each data slot can be used to transmit at most 75 bytes of data and the predefined time period is set to 3 ms.

To make the audio-data transmission more efficient, in addition to transmitting the frames originated by itself, each of the audio-data transmitter devices 131, 133, 135 and 137 also relays frames originated from the other audio-data transmitter device in the same group. The audio-data receiver device 110 operated in the interlaced mode tunes in designated physical channels to listen in a half of data slots by using the channel hopping algorithm according to the physical-channel configurations set to the audio-data transmitter devices 131 and 133 and tunes in designated physical channels to listen in the other half of data slots by using the channel hopping algorithm according to the physical-channel configurations set to the audio-data transmitter devices 135 and 137 in the interlaced manner.

Refer to FIG. 6 showing a wireless transmission timing diagram for transmitting audio data by the transmitter devices 131, 133, 135 and 137 in the prolong relay mode and receiving by the audio-data receiver device 110 in the interlaced mode. Each event in each link occurs with a regular interval and contains six data slots and one control slot. Although the numbers, such as 611, 632, 613, 634, 615, 636, 651, 672, 653, 674, 655, 676 and 690, are provided to indicate the TX slots, they can also indicate the corresponding RX slots but are omitted for the brevity of FIG. 6. For example, the number 611 not only indicates the data slot for the audio-data transmitter device 131, but also indicates the data slots aligned vertically to the data slot 611 for the audio-data transmitter device 133 and the audio-data receiver devices 110. The number 651 not only indicates the data slot for the audio-data transmitter devices 135, but also indicates the data slots aligned vertically to the data slot 651 for the audio-data transmitter device 137.

For the group A, in the data slot 611, the audio-data transmitter device 131 transmits one chunk of audio data with the related CRC (so-called the frame A, shown as the block filled with slashes), which is originated by the audio-data transmitter device 131, to the audio-data receiver device 110 while the audio-data transmitter device 133 listens to the physical channel hopped in the data slot 611 and store the listened data (including the frame A theoretically) in the memory thereof. The frame A is enclosed in the payload of the media packet P621. The header of the media packet P621 records information about the device ID of the audio-data transmitter device 131, the frame ID of the frame A, the start bit number of the frame A in the payload thereof, and a flush timeout value attached to the frame A. The frame A is transmitted to the audio-data receiver device 110 in the data slot 611 for the first time.

In the data slot 632, the audio-data transmitter device 133 transmits one chunk of audio data with the related CRC (so-called the frame B, shown as the block filled with dots), which is originated by the audio-data transmitter device 133, to the audio-data receiver device 110, and transmits the data listened in the data slot 611 to the audio-data receiver device 110 while the audio-data transmitter device 131 listens to the physical channel hopped in the data slot 632 and store the listened data (including the frame B theoretically) in the memory thereof. The frames A and B are enclosed in the payload of the media packet P622. The header of the media packet P622 records information about the device ID of the audio-data transmitter device 131, the frame ID of the frame A and the start bit number of the frame A in the payload thereof, and a flush timeout value attached to the frame A, as well as the device ID of the audio-data transmitter device 133, the frame ID of the frame B and the start bit number of the frame B in the payload thereof, and a flush timeout value attached to the frame B. It is to be understood that the audio-data transmitter device 131 drops the frame A listened in the data slot 632 because the frame A is originated by itself. The frame A is transmitted to the audio-data receiver device 110 in the data slot 632 for the second time and the frame B is transmitted to the audio-data receiver device 110 in the data slot 632 for the first time.

In the data slot 613, the audio-data transmitter device 131 transmits the frame A to the audio-data receiver device 110 and transmits the data (including frame B) listened in the data slot 632 to the audio-data receiver device 110 while the audio-data transmitter device 133 listens to the physical channel hopped in the data slot 613 and store the listened data (including frame A theoretically) in the memory thereof. The payload of the media packet P623 encloses the frames A and B, and the header of the media packet P623 records the aforementioned information for the frames A and B. It is to be understood that the audio-data transmitter device 133 drops the frame B listened in the data slot 613 because the frame B is originated by itself. The frame A is transmitted to the audio-data receiver device 110 in the data slot 613 for the third time and the frame B is transmitted to the audio-data receiver device 110 in the data slot 613 for the second time. The behaviors acted by the audio-data transmitter devices 131 and 133 in the data slots 634, 615 and 636 can be deduced by analogy and are omitted herein for brevity.

The frame A is transmitted to the audio-data receiver device 110 through the media packets P624, P625 and P626 in the data slots 634, 615 and 636 for the fourth, the fifth and the sixth times, respectively. The frame B is transmitted to the audio-data receiver device 110 through the media packets P624, P625 and P626 in the data slots 634, 615 and 636 for the third, the fourth and the fifth times, respectively. The frame B is transmitted to the audio-data receiver device 110 for the sixth time in the first data slot of the next regular interval (not shown in FIG. 6).

The audio-data transmitter device 131 in the prolong relay mode deems the data slots 611, 613 and 615 as TX slots for transmitting data while the audio-data transmitter device 133 in the prolong relay mode and the audio-data receiver device 110 in the interlaced mode deems the data slots 611, 613 and 615 as RX slots for receiving data. The audio-data transmitter device 133 in the prolong relay mode deems the data slots 632, 634 and 636 as TX slots for transmitting data while the audio-data transmitter device 131 in the prolong relay mode deems the data slots 632, 634 and 636 as RX slots for receiving data.

For the group B, in the data slot 651, the audio-data transmitter device 135 transmits one chunk of audio data with the related CRC (so-called the frame C, shown as the block with backslashes), which is originated by the audio-data transmitter device 135, to the audio-data receiver device 110 while the audio-data transmitter device 137 listens to the physical channel hopped in the data slot 651 and store the listened data (including the frame C theoretically) in the memory thereof. The frame C is enclosed in the payload of the media packet P641. The header of the media packet P641 records information about the device ID of the audio-data transmitter device 135, the frame ID of the frame C, the start bit number of the frame C in the payload thereof, and a flush timeout value attached to the frame C. The frame C is transmitted to the audio-data receiver device 110 in the data slot 651 for the first time.

In the data slot 672, the audio-data transmitter device 137 transmits one chunk of audio data with the related CRC (so-called the frame D, shown as the block filled with vertical lines), which is generated by the audio-data transmitter device 137, to the audio-data receiver device 110, and transmits the data (including frame C) listened in the data slot 651 to the audio-data receiver device 110 while the audio-data transmitter device 135 listens to the physical channel hopped in the data slot 672 and store the listened data (including the frame D theoretically) in the memory thereof The frames C and D are enclosed in the payload of the media packet P642. The header of the media packet P642 records information about the device ID of the audio-data transmitter device 135, the frame ID of the frame C, the start bit number of the frame C in the payload thereof, and a flush timeout value attached to the frame C, as well as the device ID of the audio-data transmitter device 137, the frame ID of the frame D, the start bit number of the frame D in the payload thereof, and a flush timeout value attached to the frame D. It is to be understood that the audio-data transmitter device 135 drops the frame C listened in the data slot 672 because the frame C is originated by itself. The frame C is transmitted to the audio-data receiver device 110 in the data slot 672 for the second time and the frame D is transmitted to the audio-data receiver device 110 in the data slot 672 for the first time.

In the data slot 653, the audio-data transmitter device 135 transmits the frame C to the audio-data receiver device 110 and transmits the data (including frame D) listened in the data slot 672 to the audio-data receiver device 110 while the audio-data transmitter device 137 listens to the physical channel hopped in the data slot 653 and store the listened data (including frames C and D theoretically) in the memory thereof. The payload of one media packet P643 encloses the frames C and D, and the header of the media packet P643 records the aforementioned information for the frames C and D. It is to be understood that the audio-data transmitter device 137 drops the frame D listened in the data slot 653 because the frame D is originated by itself. The frame C is transmitted to the audio-data receiver device 110 in the data slot 653 for the third time and the frame D is transmitted to the audio-data receiver device 110 in the data slot 653 for the second time. The behaviors acted by the audio-data transmitter devices 135 and 137 in the data slots 674, 655 and 676 can be deduced by analogy and are omitted herein for brevity.

The frame C is transmitted to the audio-data receiver device 110 through the media packets P644, P645 and P646 in the data slots 674, 655 and 676 for the fourth, the fifth and the sixth times, respectively. The frame D is transmitted to the audio-data receiver device 110 through the media packets P644, P645 and P646 in the data slots 674, 655 and 676 for the third, the fourth and the fifth times, respectively. The frame D is transmitted to the audio-data receiver device 110 for the sixth time in the first data slot of the next regular interval (not shown in FIG. 6).

The audio-data transmitter device 135 in the prolong relay mode deems the data slots 651, 653 and 655 as TX slots for transmitting data while the audio-data transmitter device 137 in the prolong relay mode deems the data slots 651, 653 and 655 as RX slots for receiving data. The audio-data transmitter device 137 in the prolong relay mode deems the data slots 672, 674 and 676 as TX slots for transmitting data while the audio-data transmitter device 135 in the prolong relay mode and the audio-data receiver device 110 deems the data slots 672, 674 and 676 as RX slots for receiving data.

The audio-data receiver device 110 may transmit updated setup parameters, such as a new encryption key, new physical-channel configurations, and so on, for the following events to the audio-data transmitter devices 131, 133, 135 and 137 in the control signal slot 690 The audio-data receiver device 110 deems the control signal slot 690 as a TX slot for transmitting the updated setup parameters while the audio-data transmitter devices 131, 133, 135 and 137 deems the control signal slot 690 as a RX slot for receiving the updated setup parameters.

Since the audio-data receiver device 110 is equipped with a single RF module to receive data from the four audio-data transmitter devices 131, 133, 135 and 137, the audio-data receiver device 110 listens to the designated physical channels for the links A and B in the interlaced manner. Specifically, the audio-data receiver device 110 sequentially listens to the designated physical channels hopped in the data slot 611 for the link A, the data slot 672 for the link B, the data slot 613 for the link A, the data slot 674 for the link B, and so on. As a result, the frame A is received by the audio-data receiver device 110 for the first time in the data slot 611. Both the frames C and D are received by the audio-data receiver device 110 for the first time in the data slot 672. The frame B is received by the audio-data receiver device 110 for the first time and the frame A is received by the audio-data receiver device 110 for the second time in the data slot 613. Both the frames C and D are received by the audio-data receiver device 110 for the second time in the data slot 674. The frame B is received by the audio-data receiver device 110 for the second time and the frame A is received by the audio-data receiver device 110 for the third time in the data slot 615. Both the frames C and D are received by the audio-data receiver device 110 for the third time in the data slot 676. The process of obtaining the data originated from the other audio-data transmitter device in the same group and transmitting the listened data to the audio-data receiver device 110 by the audio-data transmitter devices 131, 133, 135 or 137 is referred to as a relay process.

Similarly, an audio-data collecting device equipped with the audio-data transmitter device 135 may further include a microphone and an ADC converter to repeatedly generate audio data. The processing unit 242 of the audio-data transmitter device 135 when loading and executing relevant firmware code, software code or the both generates the frame C with a similar procedure based on the audio data originated from the ADC of the audio-data collecting device. An audio- data collecting device equipped with the audio-data transmitter device 137 may further include a microphone and an ADC converter to repeatedly generate audio data. The processing unit 242 of the audio-data transmitter device 137 when loading and executing relevant firmware code, software code or the both generates the frame D with a similar procedure based on the audio data originated from the ADC of the audio-data collecting device.

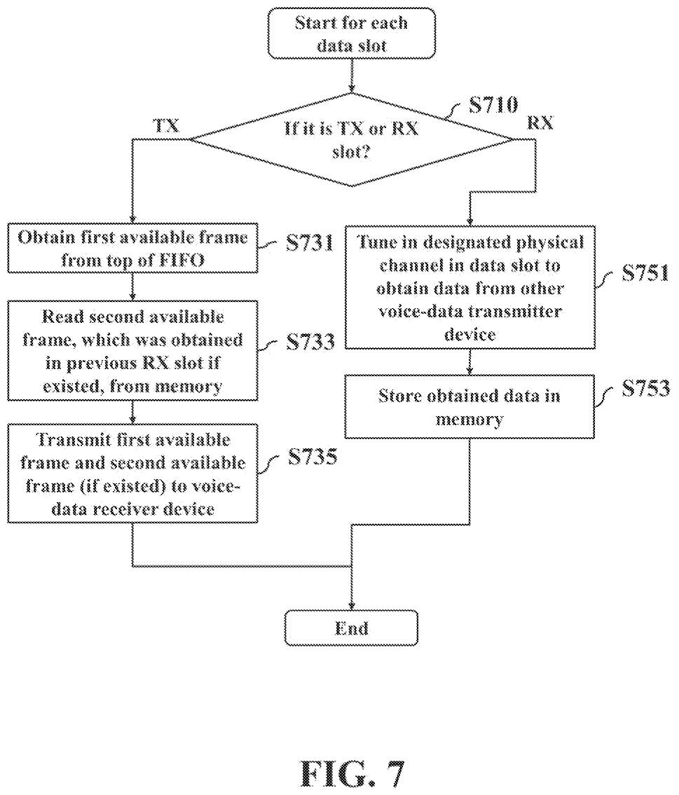

An embodiment of the method for executing tasks for each data slot is performed by a processing unit of an audio-data transmitter device (e.g. the processing unit 242 of the audio-data transmitter device 131, 133, 135 or 137) when loading and executing relevant firmware codes, software codes, or the both, to operate in the relay mode or the prolong relay mode. It is to be understood that, if not specified, the RF module 220, the MODEM 230, the processing unit 242 and the memory 244 mentioned in the passages associated with FIG. 7 is installed in a corresponding audio-data transmitter device (such as the audio-data transmitter device 131, 133, 135 or 137). Detailed steps as shown in FIG. 7 are described as follows:

Step S710: It is determined whether this data slot is a TX or RX slot according to the updated setup messages obtained from the audio-data receiver device 110. If this data slot is a TX slot, the process proceeds to step S731; otherwise, the process proceeds to step S751.

Step S731: The available frame (i.e. the first available frame) is obtained from the top of the FIFO. The first available frame is the frame that is originated by this audio-data transmitter device. It is noted that any expired frame (i.e. the frame attached with a flush timeout value, which is later than the start time of this data slot) is dropped from the top of the FIFO.

Step S733: The available frame (i.e. the second available frame), which was obtained in the previous RX slot if existed, is read from the memory 244. The second available frame is the frame that is originated from another audio-data transmitter device. It is noted that any expired frame (i.e. the frame attached with a flush timeout value, which is earlier than the start time of this data slot) read from the memory 244 is dropped.

It is noted that the available frame recited in steps S731 and S733 means the frame attached with a flush timeout value, which is later than the start time of this data slot.

Step S735: The MODEM 230 and the RF module 220 is driven to transmit a media packet including the first available frame and the second available frame (if existed) at the designated physical channel in this data slot. The processing unit 242 encapsulates the first available frame and the second available frame (if existed) into the payload of one media packet for transmission. The processing unit 242 may fill with a guard pattern between the first and second available frames in the payload of the media packet. The processing unit 242 generates the header of the media packet recording information about the frame IDs of the first and second available frames, the device IDs of the audio-data transmitter devices that originally provide the first and second available frames, start bit numbers of the first and second available frames in the payload, and first and second flush timeout values attached to the first and second available frames, respectively.

Step S751: The MODEM 230 and the RF module 220 is driven to tune in the designated physical channel in this data slot to obtain data from the other audio-data transmitter device.

Step S753: The obtained data is stored in the memory 244.

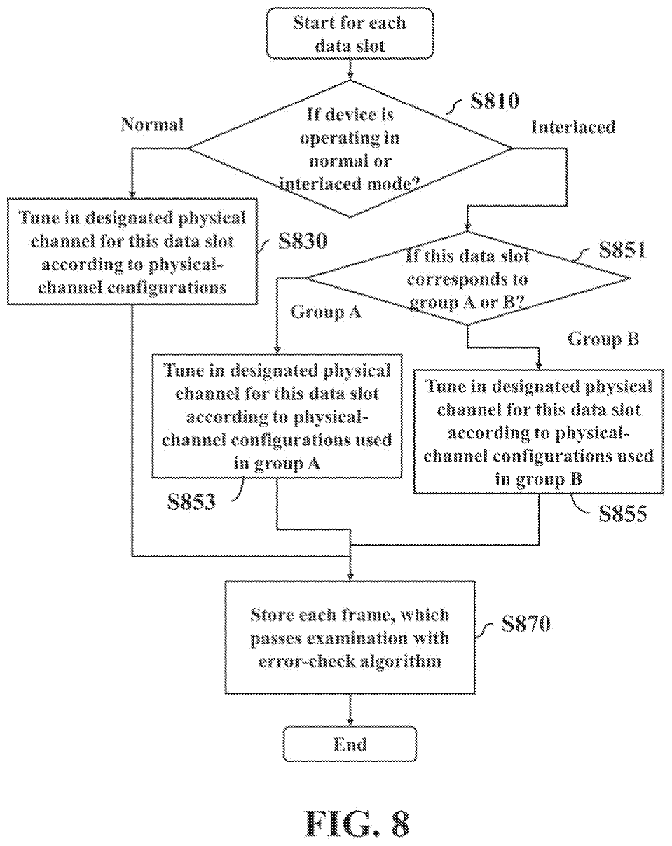

An embodiment of the method for executing tasks for each data slot, which is performed by a processing unit 242 of an audio-data receiver device 110 when loading and executing relevant firmware codes, software codes, or the both. It is to be understood that, if not specified, the RF module 220, the MODEM 230, the processing unit 242 and the memory 244 mentioned in the passages associated with FIG. 8 indicate that are installed in the audio-data receiver device 110. Detailed steps as shown in FIG. 8 are described as follows:

Step S810: It is determined whether the audio-data receiver device 110 is operating in the normal or the interlaced mode. If the audio-data receiver device 110 is operating in the normal mode, the process proceeds to step S830. If the audio-data receiver device 110 is operating in the interlaced mode, the process proceeds to step S851.

Step S830: The MODEM 230 and the RF module 220 is driven to tune in the designated physical channel in this data slot to obtain data according to the physical-channel configurations set to the audio-data transmitter devices.

Step S851: It is determined which one of the group A and B that this data slot corresponds to. If this data slot corresponds to the group A, the process proceeds to step S853. If this data slot corresponds to the group B, the process proceeds to step S855.

Step S853: The MODEM 230 and the RF module 220 is driven to tune in the designated physical channel in this data slot to obtain data according to the physical-channel configurations set to the audio-data transmitter devices in the group A.

Step S855: The MODEM 230 and the RF module 220 is driven to tune in the designated physical channel in this data slot to obtain data according to the physical-channel configurations set to the audio-data transmitter devices in the group B.

In each of steps S830, S853 and S855, the processing unit 242 obtains the header and the payload of the media packet from the listened data at the tuned-in physical channel. The processing unit 242 parses the header to know how many frames are enclosed in the media packet, the flush timeout values attached to each frame, and the start bit number of each frame in the payload, and obtains one chunk of audio data and the related CRC in each frame accordingly.

Step S870, each frame, which passes the verification with the error-check algorithm, is stored in the memory 244. It is noted each frame, which cannot pass the verification, is dropped. The stored frame may be fed into a specific application, such as a multi-media recorder, an audio playback, etc., to process.

Some or all of the aforementioned embodiments of the method of the invention may be implemented in a computer program, such as a driver of a dedicated hardware, digital signal processor (DSP) code in a specific programming language, or others. Other types of programs may also be suitable, as previously explained. Since the implementation of the various embodiments of the present invention into a computer program can be achieved by the skilled person using his routine skills, such an implementation will not be discussed for reasons of brevity. The computer program implementing some or more embodiments of the method of the present invention may be stored on a suitable computer-readable data carrier, or may be located in a network server accessible via a network such as the Internet, or any other suitable carrier.

A computer-readable storage medium includes volatile and non-volatile, removable and non-removable media implemented in any method or technology for storage of information such as computer-readable instruction, data structures, program modules, or other data. A computer-readable storage medium includes, but is not limited to, RAM, ROM, EEPROM, flash memory or other memory, CD-ROM, digital versatile disks (DVD), Blue-ray disk or other optical storage, magnetic cassettes, magnetic tape, magnetic disk or other magnetic storage devices, or any other medium which can be used to store the desired information and may be accessed by an instruction execution system. Note that a computer-readable medium can be paper or other suitable medium upon which the program is printed, as the program can be electronically captured via, for instance, optical scanning of the paper or other suitable medium, then compiled, interpreted, or otherwise processed in a suitable manner, if necessary, and then stored in a computer memory.

Although the embodiment has been described as having specific elements in FIG. 2, it should be noted that additional elements may be included to achieve better performance without departing from the spirit of the invention. Each element of FIG. 2 is composed of various circuits and arranged to operably perform the aforementioned operations. While the process flows described in FIGS. 7 and 8 include a number of operations that appear to occur in a specific order, it should be apparent that these processes can include more or fewer operations, which can be executed serially or in parallel (e.g., using parallel processors or a multi-threading environment).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for transmitting a wireless multi-source packet, performed by a processing unit of a first audio-data transmitter device, comprising:
obtaining data-slot assignments indicating that a first data slot is assigned to a second audio-data transmitter device and a second data slot is assigned to the first audio-data transmitter device for data transmission from an audio-data receiver device;
tuning in a first physical channel in the first data slot to obtain a first frame from the second audio-data transmitter device, wherein the first frame comprises a chunk of first audio data originated by the second audio-data transmitter device;
obtaining a second frame comprising a chunk of second audio data originated by the first audio-data transmitter device;
encapsulating the first frame and the second frame into a payload of a media packet; and
transmitting the media packet at a second physical channel to the audio-data receiver device in the second data slot.

2. The method of claim 1, comprising:
storing the first frame in a memory; and
reading the first frame from the memory before a generation of the media packet.

3. The method of claim 1, wherein the audio-data receiver device operates as a master device to control times and packet channels of packet transmissions performed by the first audio-data transmitter device and the second audio-data transmitter device, and the first audio-data transmitter device and the second audio-data transmitter device operate as slave devices.

4. The method of claim 1, wherein any of the first audio-data transmitter device and the second audio-data transmitter device is installed in a handheld, handset or lavalier wireless digital microphone.

5. The method of claim 1, wherein the first frame is attached with a first flush timeout value that is later than a start time of the second data slot, and the second frame is attached with a second flush timeout value that is later than the start time of the second data slot.

6. The method of claim 5, comprising:
dropping a third frame attached with a third flush timeout value that is earlier than the start time of the second data slot, so that the third frame is not transmitted in the second data slot.

7. The method of claim 1, wherein a header of the media packet records information about a first device ID of the first audio-data transmitter device that originally provides the second frame, a second device ID of the second audio-data transmitter device that originally provides the first frame, a first start bit number of the first frame in the payload of the media packet, and a second start bit number of the second frame in the payload of the media packet.

8. A non-transitory computer-readable storage medium having stored therein program code that, when loaded and executed by a processing unit of a first audio-data transmitter device, causes the processing unit to:
obtain data-slot assignments indicating that a first data slot is assigned to a second audio-data transmitter device and a second data slot is assigned to the first audio-data transmitter device for data transmission from an audio-data receiver device;
tune in a first physical channel in the first data slot to obtain a first frame from the second audio-data transmitter device, wherein the first frame comprises a chunk of first audio data originated by the second audio-data transmitter device;
obtain a second frame comprising a chunk of second audio data originated by the first audio-data transmitter device;
encapsulate the first frame and the second frame into a payload of a media packet; and
transmit the media packet at a second physical channel to the audio-data receiver device in the second data slot.

9. The non-transitory computer-readable storage medium of claim 8, wherein the audio-data receiver device operates as a master device to control times and packet channels of packet transmissions performed by the first audio-data transmitter device and the second audio-data transmitter device, and the first audio-data transmitter device and the second audio-data transmitter device operate as slave devices.

10. The non-transitory computer-readable storage medium of claim 8, wherein any of the first audio-data receiver device and the second audio-data transmitter device is installed in a handheld, handset or lavalier wireless digital microphone.

11. The non-transitory computer-readable storage medium of claim 8, wherein the first frame is attached with a first flush timeout value that is later than a start time of the second data slot, and the second frame is attached with a second flush timeout value that is later than the start time of the second data slot.

12. The non-transitory computer-readable storage medium of claim 11, wherein the program code that, when loaded and executed by the processing unit of the first audio-data transmitter device, causes the processing unit to:
drop a third frame attached with a third flush timeout value that is earlier than the start time of the second data slot, so that the third frame is not transmitted in the second data slot.

13. An apparatus for transmitting a wireless multi-source packet, installed in a first audio-data transmitter device, comprising:
a processing unit, arranged operably to:
obtain data-slot assignments indicating that a first data slot is assigned to a second audio-data transmitter device and a second data slot is assigned to first audio-data transmitter device for data transmission from an audio-data receiver device;
drive a radio frequency (RF) module and a modulator-demodulator (MODEM) to tune in a first physical channel in the first data slot to obtain a first frame from the second audio-data transmitter device, wherein the first frame comprises a chunk of first audio data originated by the second audio-data transmitter device;
obtain a second frame comprising a chunk of second audio data originated by the first audio-data transmitter device;
encapsulate the first frame and the second frame into a payload of a media packet; and
drive the RF module and the MODEM to transmit the media packet at a second physical channel to the audio-data receiver device in the second data slot.

14. The apparatus of claim 13, wherein the audio-data receiver device operates as a master device to control times and packet channels of packet transmissions performed by the first audio-data transmitter device and the second audio-data transmitter device, and the first audio-data transmitter device and the second audio-data transmitter device operate as slave devices.

15. The apparatus of claim 13, wherein any of the first audio-data transmitter device and the second audio-data transmitter device is installed in a handheld, handset or lavalier wireless digital microphone.

16. The apparatus of claim 13, the first frame is attached with a first flush timeout value that is later than a start time of the second data slot, and the second frame is attached with a second flush timeout value that is later than the start time of the second data slot.

17. The apparatus of claim 16, wherein the processing unit is arranged operably to drop a third frame attached with a third flush timeout value that is earlier than the start time of the second data slot, so that the third frame is not transmitted in the second data slot.

18. The apparatus of claim 13, wherein a header of the media packet recording information about a first device ID of the first audio-data transmitter device that originally provides the second frame, a second device ID of the second audio-data transmitter device that originally provides the first frame, a first start bit number of the first frame in the payload of the media packet, and a second start bit number of the second frame in the payload of the media packet.

19. A method for receiving a wireless multi-source packet, performed by a processing unit of a audio-data receiver device, comprising:
transmitting first data-slot assignments indicating that a first data slot is assigned to a second audio-data transmitter device and a second data slot is assigned to a first audio-data transmitter device for data transmission to the first audio-data transmitter device;
transmitting a first transmission mode being set to a specific mode, and a first physical-channel configuration to the first audio-data transmitter device, thereby enabling the first audio-data transmitter device to relay a first frame that is listened in the first data slot to the audio-data receiver device, wherein the first frame comprises a chunk of first audio data originated by the second audio-data transmitter device; and
tuning in a first physical channel in the second data slot to receive a first media packet from the first audio-data transmitter device, wherein the first media packet comprises a first payload carrying the first frame and a second frame, wherein the second frame comprises a chunk of second audio data originated by the first audio-data transmitter device.

20. The method of claim 19, comprising:
parsing a header of the first media packet to know a first start bit number of the first frame and a second start bit number of the second frame in the first payload of the first media packet; and
obtaining the first frame and the second frame from the first payload of the first media packet.

21. The method of claim 19, comprising:
transmitting second data-slot assignments indicating that a third data slot is assigned to a fourth audio-data transmitter device and a fourth data slot is assigned to a third audio-data transmitter device for data transmission to the third audio-data transmitter device;
transmitting a second transmission mode being set to the mode, and a second physical-channel configuration to the third audio-data transmitter device, thereby enabling the third audio-data transmitter device to relay a third frame that is listened in the third data slot to the audio-data receiver device, wherein the third frame comprises a chunk of third audio data originated by the fourth audio-data transmitter device; and
tuning in a second physical channel in the fourth data slot to receive a second media packet from the third audio-data transmitter device, wherein the second media packet comprises a second payload carrying the third frame and a fourth frame, wherein the fourth frame comprises a chunk of fourth audio data originated by the third audio-data transmitter device,
wherein the first physical-channel configuration is different from the second physical-channel configuration to enable the first audio-data transmitter device and the second audio-data transmitter device to share a first link and enable the third audio-data transmitter device and the fourth audio-data transmitter device to share a second link.

22. A non-transitory computer-readable storage medium having stored therein program code that, when loaded and executed by a processing unit of an audio-data receiver device, causes the processing unit to:
transmit first data-slot assignments indicating that a first data slot is assigned to a second audio-data transmitter device and a second data slot is assigned to a first audio-data transmitter device for data transmission to the first audio-data transmitter device;
transmit a first transmission mode being set to a specific mode, and a first physical-channel configuration to the first audio-data transmitter device, thereby enabling the first audio-data transmitter device to relay a first frame that is listened in the first data slot to the audio-data receiver device, wherein the first frame comprises a chunk of first audio data originated by the second audio-data transmitter device; and
tune in a first physical channel in the second data slot to receive a first media packet from the first audio-data transmitter device, wherein the first media packet comprises a first payload carrying the first frame and a second frame, wherein the second frame comprises a chunk of second audio data originated by the first audio-data transmitter device.

23. The non-transitory computer-readable storage medium of claim 22, wherein the program code that, when loaded and executed by the processing unit of the audio-data receiver device, causes the processing unit to:
parse a header of the first media packet to know a first start bit number of the first frame and a second start bit number of the second frame in the first payload of the first media packet; and
obtain the first frame and the second frame from the first payload of the first media packet.

24. The non-transitory computer-readable storage medium of claim 22, wherein the program code that, when loaded and executed by the processing unit of the audio-data receiver device, causes the processing unit to:
transmit second data-slot assignments indicating that a third data slot is assigned to a fourth audio-data transmitter device and a fourth data slot is assigned to a third audio-data transmitter device for data transmission to the third audio-data transmitter device;
transmit a second transmission mode being set to the mode, and a second physical-channel configuration to the third audio-data transmitter device, thereby enabling the third audio-data transmitter device to relay a third frame that is listened in the third data slot to the audio-data receiver device, wherein the third frame comprises a chunk of third audio data originated by the fourth audio-data transmitter device; and
tune in a second physical channel in the fourth data slot to receive a second media packet from the third audio-data transmitter device, wherein the second media packet comprises a second payload carrying the third frame and a fourth frame, wherein the fourth frame comprises a chunk of fourth audio data originated by the third audio-data transmitter device,
wherein the first physical-channel configuration is different from the second physical-channel configuration to enable the first audio-data transmitter device and the second audio-data transmitter device to share a first link and enable the third audio-data transmitter device and the fourth audio-data transmitter device to share a second link.

25. An apparatus for receiving a wireless multi-source packet, installed in an audio-data receiver device, comprising:
a processing unit, arranged operably to:
transmit first data-slot assignments indicating that a first data slot is assigned to a second audio-data transmitter device and a second data slot is assigned to a first audio-data transmitter device for data transmission to the first audio-data transmitter device;
transmit a first transmission mode being set to a specific mode, and a first physical-channel configuration to the first audio-data transmitter device, thereby enabling the first audio-data transmitter device to relay a first frame that is listened in the first data slot to the audio-data receiver device, wherein the first frame comprises a chunk of first audio data originated by the second audio-data transmitter device; and
drive a radio frequency (RF) module and a modulator-demodulator (MODEM) to tune in a first physical channel in the second data slot to receive a first media packet from the first audio-data transmitter device, wherein the first media packet comprises a first payload carrying the first frame and a second frame, wherein the second frame comprises a chunk of second audio data originated by the first audio-data transmitter device.

26. The apparatus of claim 25, wherein the processing unit is arranged operably to:
parse a header of the first media packet to know a first start bit number of the first frame and a second start bit number of the second frame in the first payload of the first media packet; and
obtain the first frame and the second frame from the first payload of the first media packet accordingly.

27. The apparatus of claim 25, wherein the processing unit is arranged operably to:
transmit second data-slot assignments indicating that a third data slot is assigned to a fourth audio-data transmitter device and a fourth data slot is assigned to a third audio-data transmitter device for data transmission to the third audio-data transmitter device;
transmit a second transmission mode being set to the mode, and a second physical-channel configuration to the third audio-data transmitter device, thereby enabling the third audio-data transmitter device to relay a third frame that is listened in the third data slot to the audio-data receiver device, wherein the third frame comprises a chunk of third audio data originated by the fourth audio-data transmitter device; and
drive the RF module and the MODEM to tune in a second physical channel in the fourth data slot to receive a second media packet from the third audio-data transmitter device, wherein the second media packet comprises a second payload carrying the third frame and a fourth frame, wherein the fourth frame comprises a chunk of fourth audio data originated by the third audio-data transmitter device,
wherein the first physical-channel configuration is different from the second physical-channel configuration to enable the first audio-data transmitter device and the second audio-data transmitter device to share a first link and enable the third audio-data transmitter device and the fourth audio-data transmitter device to share a second link.
